(19) United States
(12) Patent Application Publication
(10) Pub. No.: US 2009/0140837 A1
(43) Pub. Date: Jun. 4, 2009

(54) RF Token and Receptacle System and Method

(76) Inventor: Glen Eric Jennings, Savage, MN (US)

Correspondence Address: DORSEY & WHITNEY LLP;INTELLECTUAL PROPERTY DEPARTMENT, SUITE 1500, 50 SOUTH SIXTH STREET, MINNEAPOLIS, MN, 55402-1498, US

(21) Appl. No.: 12/177,016

(22) Filed: Jul. 21, 2008

Related U.S. Application Data
(60) Provisional application No. 60/950,832, filed on Jul. 19, 2007.

(51) Int. Cl. H04Q 9/00

(52) U.S. Cl. 340/5.66

(57) ABSTRACT

An electronic token system includes a token receptacle and a portable token. The receptacle includes an RF transceiver antenna. The portable token includes a RF data exchange circuit, an enclosure for enclosing the exchange circuit, and a magnetic coupling member having an antenna in communication with the exchange circuit. The antenna is mounted in a projection extending radially from the token enclosure. A keyway is provided in the receptacle for receiving and guiding insertion of the token. The keyway is configured to receive the token in an insertion position in which the magnetic coupling member is not operably coupled to the receptacle's RF transceiver antenna and, upon token rotation, to guide the token to an activation position in which the magnetic coupling member is operably coupled to the RF transceiver antenna. The present disclosure further relates to improved security and RF dissipation and decreased RF leakage of the token system.

### CROSS-REFERENCE TO RELATED APPLICATIONS(S)

This application claims priority to U.S. Provisional Patent Application No. 60/950,832, filed Jul. 19, 2007, and is related to U.S. patent application Ser. No. 10/112,989, filed Mar. 29, 2002, now issued as U.S. Pat. No. 7,158,008, the subject matter of each being hereby incorporated by reference herein in its entirety.

### FIELD OF THE INVENTION

The present disclosure relates generally to an electronic data carrier system. Particularly, the present disclosure relates to apparatus and methods for electronic data carriers and receptacles therefor. More particularly, the present disclosure relates to apparatus and methods for an electronic data carrier system comprising an electrical/electronic token device and token receptacle having a radio frequency (“RF”) or electromagnetic coupling member arranged and configured on a skeleton key-style tip of the token device and a corresponding transceiver antenna member arranged and configured on, or operably coupled to, a circuit board at the token receptacle. The present disclosure further relates to improved security and RF dissipation and decreased RF leakage of an electronic data carrier.

### BACKGROUND OF THE INVENTION

Electronic token data carrier systems have been used in many applications and have proven to be a source for portable information solutions. For example, electronic token systems have been used in data logging applications wherein a portable electrical/electronic token device stores user and/or other information for transport of data to/from a remote station; in access control applications where a portable token device stores information to be verified by an access control program or system; in cashless vending or cash token applications wherein a portable electrical/electronic token device stores a value (e.g., cash value or number of credits, etc.) that is decremented after, for example, vending a product, and can be recharged with additional value; and in security applications wherein a portable electrical/electronic token device stores personal identification information that is valid only when the electrical/electronic token device is being used by the owner or authorized personnel of the electrical/electronic token device.

Prior electronic token data carrier systems include various embodiments of electrical/electronic token devices and electrical token receptacles disclosed in U.S. Pat. No. 4,752,679, entitled “RECEPTACLE DEVICE,” issued on Jun. 21, 1988; U.S. Pat. No. 4,659,915, entitled “RECEPTACLE DESIGN FOR USE WITH ELECTRONIC KEY-LIKE DEVICE,” issued on Apr. 21, 1987; U.S. Pat. No. 4,522,456, entitled “ELECTRONIC TAG RECEPTACLE AND READER,” issued on Jun. 11, 1985; U.S. Pat. No. 4,620,088, entitled “RECEPTACLE DESIGN FOR USE WITH ELECTRONIC KEY-LIKE DEVICE,” issued on Oct. 28, 1986; U.S. Design Pat. D345,686, entitled “ELECTRICAL INFORMATION KEY,” issued on Apr. 5, 1994; U.S. Pat. No. 4,578,573, entitled “PORTABLE ELECTRONIC INFORMATION DEVICES AND METHOD OF MANUFACTURE,” issued on Mar. 25, 1986; U.S. Pat. No. 4,549,076, entitled “ORIENTATION GUIDE ARRANGEMENT FOR ELECTRONIC KEY AND RECEPTACLE COMBINATION,” issued on Oct. 22, 1985; U.S. Pat. No. 4,436,993, entitled “ELECTRONIC KEY,” issued on Mar. 13, 1984; U.S. Pat. No. 5,073,703, entitled “APPARATUS FOR ENCODING ELECTRICAL IDENTIFICATION DEVICES BY MEANS OF SELECTIVELY FUSIBLE LINKS,” issued on Dec. 17, 1991; U.S. Design Pat. D291,897, entitled “IDENTIFICATION TAG,” issued on Sep. 15, 1987; U.S. Pat. No. 4,326,125, entitled “MICROELECTRONIC MEMORY KEY WITH RECEPTACLE AND SYSTEMS THEREFOR,” issued on Apr. 20, 1982; and U.S. Pat. No. 4,297,569, entitled “MICROELECTRONIC MEMORY KEY WITH RECEPTACLE AND SYSTEMS THEREFOR,” issued on Oct. 27, 1981; all of which are assigned to Datakey Electronics, Inc., the assignee of the present application, and all of which are hereby incorporated herein by reference in their entirety.

The above-referenced electronic token systems disclose electrical/electronic token devices and receptacles. In general, a circuit or electrical operation system is activated by use of a portable token device, which is inserted into a receptacle or the like, to make electrical contact or connection with the outside circuit or the electrical operation system. Such electrical contact or connection is generally made by rotating the token device after the token is fully inserted into the receptacle, whereby a plurality of spring contact pins of the receptacle mate with contacts of the token device. Electrical pathways or wires/traces in the receptacle electrically connect the spring contact pins to an interface of the receptacle. The interface carries electrical signals from the token device to the outside circuit or electrical operation system.

It has been recognized that the contacts of the token device and the receptacle are subject to wear and tear not only because of the mechanical contact, but also because the contacts of a token device are exposed to an outside environment without protection. Therefore, it is desirable to have a contactless electronic token system.

U.S. Pat. No. 7,158,008, which was previously incorporated herein by reference, introduces an RF token data carrier system. Typical RF reprogrammable memories (“RFRM”) operate in unlicensed frequency bands of 125 KHz (LF) and 13.56 MHz (HF). Other available frequencies include 800-900 MHz (UHF) and 2.4 GHz.

The distance at which a RFRM can be read is known as the read range. The read range of a RFRM depends on many factors besides just its frequency of operation, such as the physical properties of the antenna, the power of the reader, and interference in the RF transmission path caused by lossy materials such as air, water, or dielectrics. Typical maximum read ranges include: LF—one (1) foot; HF—three (3) feet; and UHF—twenty (20) feet. However, recommended read ranges are much less than maximums listed above.

Secure communications products, such as those used by governmental organizations, can be used to encrypt the information they transfer. These secure communications could include radio, telecom, or data communications. The devices that are used to secure those communications are themselves a security concern because if they fell into the wrong hands, they could be used to monitor or even spoof the legitimate users. As such, one common requirement is that the communications equipment have a removable data carrier that, upon removal, renders the equipment useless. If the data carrier and the equipment it is configured to mate with are maintained physically separated, there is potentially minimal, or no, security risk. Benefits of using RFRM in such cases can include that RFRM can be used for an extremely large number of mating cycles without wearing out, it can be relatively small, and receptacles for receiving an RFRM device can be made substantially impervious to environmental elements (e.g., rain, salt, fog, dust, shock, vibration, etc.).

However, since RFRMs “transmit” their information, there is a possibility that the transmissions can be “sniffed” or otherwise intercepted by an enemy. If the enemy were to record these transmissions, they could potentially design circuitry that could clone the data carrier's RFRM and be used to defeat the security that was supposed to be provided by the RFRM. This situation is analogous to the reason that garage door openers have “rolling codes” to prevent unscrupulous people from gaining access to garages by sniffing transmissions and cloning the door opener (transmitter). Other exemplary applications where preventing sniffing could be very beneficial include, but are not limited to, using a RFRM to carry cash value (e.g., cashless vending), for access control to electronic systems or to facilities, and crypto-ignition keys, or CIKs.

The various embodiments described herein improve upon the RF token data carrier system described in described in U.S. Pat. No. 7,158,008 and other RF electronic token data carrier systems and concepts. There exists a need in the art for a practical solution to address RFRM applications in sensitive security situations. There is a need in the art for a practical solution, particularly apparatus and methods for electronic data carriers and receptacles therefor, to address the problems of intercepting transmissions and detecting the presence of RF whatsoever (e.g., giving away a person's position) in RFRM applications. There is a further need in the art for rugged electronic token data carrier systems with added security and decreased RF transmission leakage.

### BRIEF SUMMARY OF THE INVENTION

The various embodiments of the present disclosure provide solutions for, among other things, the problems identified above. The present disclosure, in one embodiment, relates to an electronic token system for data exchange with a device. The electronic token system includes a token receptacle and a portable token for mating with the token receptacle. The receptacle is operably connected to the device and has an insertion opening and an RF transceiver antenna. The portable token includes a RF data exchange circuit, an enclosure with a proximate end and a distal end for enclosing the RF data exchange circuit, and a magnetic coupling member placed adjacent the distal end of the token and in communication with the RF data exchange circuit. The antenna is mounted in a planar projection extending outward from a rotational axis of the enclosure. A keyway is provided in the token receptacle for receiving and guiding insertion of the portable token. The keyway is configured to receive the token in an insertion position in which the magnetic coupling member is not operably coupled to the token receptacle's RF transceiver antenna and, upon token rotation, to guide the token to an activation position in which the magnetic coupling member is operably coupled to the RF transceiver antenna.

The present disclosure, in another embodiment, relates to an electronic token system for data exchange with a device. The electronic token system includes a token receptacle and a portable token for mating with the token receptacle. The receptacle is operably connected to the device and has an insertion opening and an RF transceiver antenna. The portable token includes a RF data exchange circuit, an enclosure with a proximate end and a distal end for enclosing the RF data exchange circuit, and a magnetic coupling member placed adjacent the distal end of the token and in communication with the RF data exchange circuit. The portable token further includes at least one step down surface extending radially from a shank of the token.

The present disclosure, in yet a further embodiment, relates to an electronic token system for data exchange with a device. The electronic token system includes a token receptacle and a portable token for mating with the token receptacle. The receptacle is operably connected to the device and has an insertion opening and an RF transceiver antenna. The portable token includes a RF data exchange circuit, an enclosure with a proximate end and a distal end for enclosing the RF data exchange circuit, and a magnetic coupling member placed adjacent the distal end of the token and in communication with the RF data exchange circuit. The electronic token system further includes shielding substantially enclosing the magnetic coupling member and transceiver antenna and guiding the magnetic field surrounding the RF transceiver antenna and the receiving antenna when the token is inserted into the token receptacle.

While multiple embodiments are disclosed, still other embodiments of the present invention will become apparent to those skilled in the art from the following detailed description, which shows and describes illustrative embodiments of the invention. As will be realized, the invention is capable of modifications in various obvious aspects, all without departing from the spirit and scope of the present invention. Accordingly, the drawings and detailed description are to be regarded as illustrative in nature and not restrictive.

### BRIEF DESCRIPTION OF THE DRAWINGS

While the specification concludes with claims particularly pointing out and distinctly claiming the subject matter that is regarded as forming the present invention, it is believed that the invention will be better understood from the following description taken in conjunction with the accompanying Figures, in which:

FIG. 1 is a perspective view of a prior art embodiment of a contactless electronic token data carrier system.

FIG. 2 is a block diagram of a prior art embodiment of a contactless electronic token data carrier system.

FIG. 3A is a schematic end view of a prior art embodiment of a contactless electronic token data carrier system with a token device inserted into a token receptacle and disposed in a non-activated state.

FIG. 3B is a schematic end view of a prior art embodiment of a contactless electronic token data carrier system with a token device inserted into a token receptacle and disposed in an activated state.

FIG. 4 is a conceptual schematic side view of a prior art embodiment of a contactless electronic token data carrier system illustrating the RF transmission field lines axial to the keyway.

FIG. 5 is a side view of a skeleton key-style RFRM electronic token in accordance with one embodiment of the present disclosure.

FIG. 6 is a cross-sectional, perspective view of the distal end of a skeleton key-style RFRM electronic token within a token receptacle in accordance with one embodiment of the present disclosure.

FIG. 7 is a cross-sectional top view of a token receptacle in accordance with one embodiment of the present disclosure illustrating the RF transmission field lines are not axial to the keyway.

FIG. 8 is an exploded, perspective view of a skeleton key-style RFRM electronic token and token receptacle in accordance with one embodiment of the present disclosure.

FIG. 9 is a side view of a stepped, skeleton key-style RFRM electronic token in accordance with one embodiment of the present disclosure.

FIG. 10 is a front view of a stepped, skeleton key-style RFRM electronic token in accordance with one embodiment of the present disclosure.

FIG. 11 is a perspective view and side view of a stepped, token receptacle in accordance with one embodiment of the present disclosure.

FIG. 12 is a side view of a skeleton key-style RFRM electronic token having shank interference rings in accordance with one embodiment of the present disclosure.

FIG. 13 is a graph illustrating exemplary, conceptual effects of the shank interferences rings of FIG. 12.

FIG. 14 is a conceptual side view of a transceiver coil and receiver coil illustrating the magnetic field lines.

FIG. 15 is a side view of a transceiver antenna member, magnetic coupling member, and keeper according to one embodiment of the present disclosure.

FIG. 16 is a side view of a transceiver antenna member, magnetic coupling member, and keeper according to another embodiment of the present disclosure.

FIG. 17 is a cross-sectional view of a transceiver antenna member, magnetic coupling member, and keeper according to yet another embodiment of the present disclosure.

FIG. 18 is a cross-sectional, top view of a transceiver antenna member, magnetic coupling member, and magnetic shielding according to one embodiment of the present disclosure.

FIG. 19 is a front view and side view of the embodiment of FIG. 18.

FIG. 20 is a side view of a transceiver antenna member and magnetic coupling member illustrating a variant of the embodiment of FIG. 18.

### DETAILED DESCRIPTION

The present disclosure relates generally to an electronic data carrier system, and particularly, apparatus and methods for electronic data carriers and receptacles therefor. More particularly, the present disclosure relates to apparatus and methods for an electronic data carrier system comprising an electrical/electronic token device and token receptacle having a radio frequency (“RF”) or electromagnetic coupling member arranged and configured on a skeleton key-style tip of the token device and a corresponding transceiver antenna member arranged and configured on, or operably coupled to, a circuit board at the token receptacle. The present disclosure further relates to improved security and RF dissipation and decreased RF leakage of an electronic data carrier system.

The present disclosure provides various embodiments of an electronic token data carrier system having an electrical/electronic token device and an intelligent token receptacle, wherein the system is capable of performing a transaction between the token device and token receptacle after the token device is inserted into the token receptacle and moved to a predetermined, activation position.

The various embodiments of the present disclosure can be used in many applications, for example, with secure communications products to encrypt governmental communications/information that may be transferred. If the data carrier and the equipment it is configured to mate with are maintained physically separated, there is potentially minimal, or no, security risk. Other exemplary applications where the various embodiments of the present disclosure can be used include, but are not limited to, using a RFRM for a data logging application for transport of data to/from a remote station, for access control to electronic systems or to facilities, for carrying a cash value (e.g., cashless vending), and for crypto-ignition keys, or CIKs.

In a data logging operation, the system reads/writes information from/to the token, and the user transports data to/from a remote station via a token receptacle. In an access control operation, the system determines whether the token is one of the permitted, or allowed, tokens. If so, the system outputs logic command, such as a user-specified length of time, etc. This application can be used for locks and gates, etc. In a cashless vending operation, the system stores an amount of value (e.g., cash value, or number of credits, etc.) on the token and decrements the value on the token after each vending operation. Once the cash, credit, etc. is used up, additional cash, credits, etc. can be recharged onto the token in a similar operation. During a cashless vending operation, a user and/or the system may also activate a dispenser, open a control, and activate the control for a length of time.

It is appreciated that the electronic token systems of the present disclosure are not limited by the term “token” or its definition. The systems of the present disclosure may also be referred to as electronic lock or locking systems, data logging systems, cashless vending systems, data decrementing systems, data access control systems, CIK systems, etc.

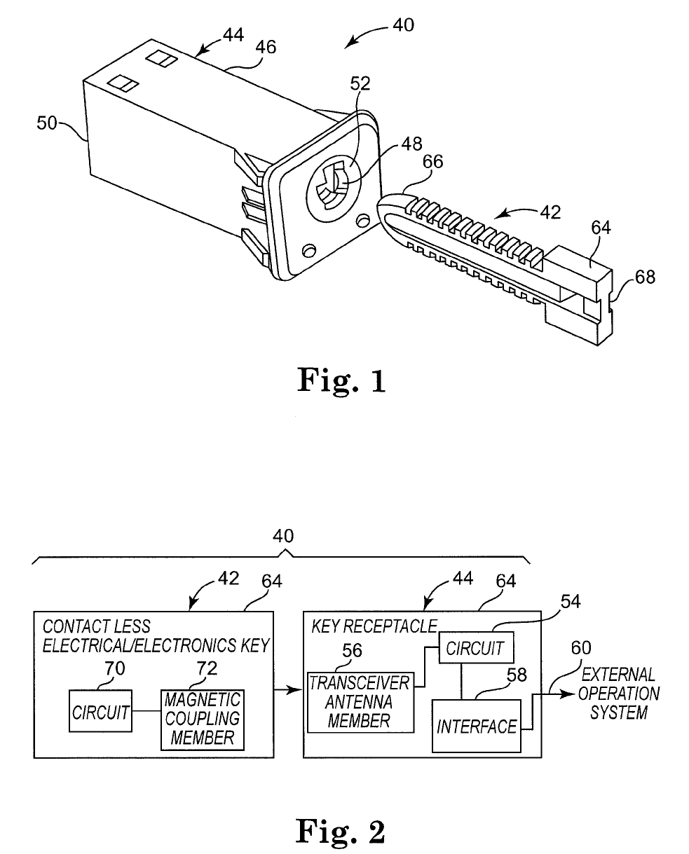

FIG. 1 illustrates an exemplary prior RFRM electronic key system 40. A system 40 includes an electrical/electronic token device 42 and a token receptacle 44. A token receptacle 44 includes a housing 46 having a slot or opening 48 configured and arranged to receive the token 42. The opening 48 has an inside end 50 and an outside end 52. As shown in FIG. 2, a token receptacle 44 also includes a circuit 54. The circuit 54 is configured and arranged to be mounted in the housing 46. The circuit 54 includes electrical traces or pathways, a processor (e.g., a suitable CPU), and at least one embedded application, addressable I/O lines, and/or communication bus/interface, that are operable for data exchange with the token device 42. The CPU, addressable I/O lines, and electrical traces or pathways can be any suitable CPU, addressable I/O lines and/or communication bus/interface, and electrical wires known in the electrical and computer art. The at least one embedded application can be any type of user application, such as reader/writer modules, etc., that are known in the electrical and computer art. The token receptacle 44 further includes a transceiver antenna member 56. The transceiver antenna member 56 is disposed in the housing 46 near the inside end 50 of the opening 48.

In some embodiments, the token receptacle 44 may include an interface 58 for interfacing an external operation system 60. As shown in FIG. 2, the interface 58 is disposed within the housing 46. In alternative embodiments, the interface 58 can be disposed outside the housing 46 and electrically connected to the circuit 54 of the receptacle 44 via wires, electric cords or other equivalent means.

The interface 58 may provide a standard interface protocol, such as RS-232, RS-485, etc., at least one input/output line, and power/ground. It should be appreciated that the interface 58 may provide other types of interface protocols, such as wireless communications, MDB (Multiple Drop Bus), USB (Universal Serial Bus), etc. By using the standard RS-232 interface protocol, the system significantly speeds up the integration cycle and eliminates chip-level interfacing, which is one of the advantages over the earlier systems. This eases the migration to new electronic token data carrier systems technologies and applications and handling of sophisticated memory security algorithms. By using the standard RS-485 interface protocol, the system not only provides the above advantages, but also provides Daisy Chain networking with relatively inexpensive twisted pair cables and long range communications (up to 1 km or more with repeaters). By using RS-485 interface protocol, the system also allows each receptacle to have a unique, programmable ID and provides access to the at least one remotely addressable logic-level outputs in case of multiple receptacle systems/configurations.

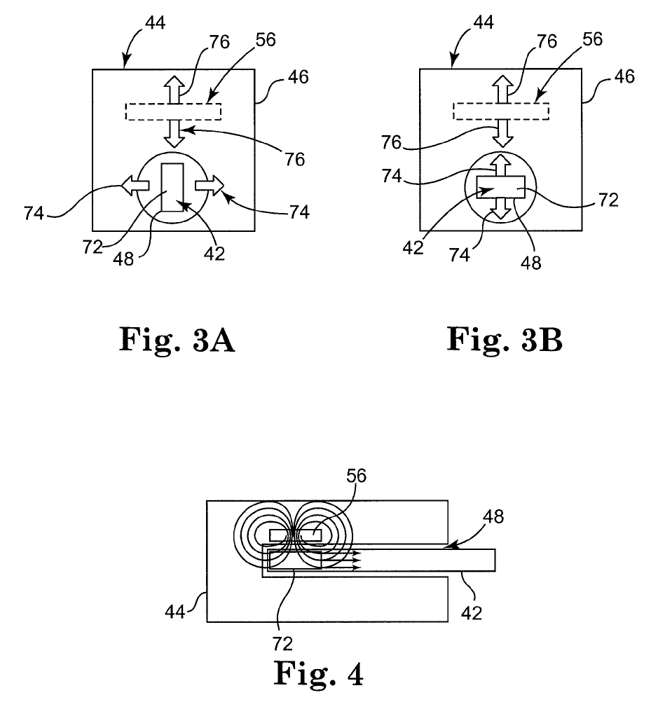

A contactless token device 42 includes a non-conductive enclosure 64 (which may also be thought of and referred to as the “body” of the token 42) having a distal end 66 and a proximal end 68. The token 42 is configured and arranged for insertion into the opening 48 of the key receptacle 44. The token 42 includes a circuit 70 disposed in and supported by the enclosure 64. The circuit 70 may be configured the same as a circuit in contact type electronic token systems disclosed in prior patents, such as U.S. Pat. Nos. 4,752,679 and 4,578,573 mentioned above, which were previously incorporated herein by reference. For example, the contactless or contact type of token may include a non-volatile, reprogrammable memory. The token 42 may include a magnetic coupling member 72 disposed in the enclosure 64 near the distal end 66 of the enclosure 64. It should be appreciated that the coupling member 72 may be located anywhere suitable with respect to the token 42. In use, the token 42 is fully inserted into the opening 48 of the receptacle 44, whereby the distal end 66 of the token 42 is disposed at or adjacent to the inside end 50 of the opening 48. As shown in FIG. 3A, the magnetic coupling member 72 is disposed adjacent to the transceiver antenna member 56. Upon insertion, the magnetic field 74 of the magnetic coupling member 72 is orthogonal to the magnetic field 76 of the transceiver antenna member 56. No energy is coupled between the magnetic field 74 and the magnetic field 76. Once the token 42 is turned a certain amount, such as ninety (90) degrees, to a position predetermined by the token and the keyway of the token receptacle in which it is inserted and turned, the magnetic field 74 of the magnetic coupling member 72 and the magnetic field 76 of the transceiver antenna member 56 are substantially aligned with each other and are fully coupled, as shown in FIG. 3B. RF signals forming a communication pathway are thus generated in the transceiver antenna member 56 to enable a transaction between the circuit 70 of the token 42 and the circuit 54 of the receptacle 44.

FIG. 4 conceptually illustrates the RF field lines from the transceiver antenna member 56 when the token device 42 is received within the token receptacle 44, and the token 42 and receptacle 44 are in RF communication with each other. When the receiving RFRM's antenna intersects the near-field, its own multiple overlapping loops allow the magnetic field energy to be “harvested” and turned into electric currents that are carried into and used to power the RFRM. As illustrated in FIG. 4, a portion of the RF field lines are axially aligned with the keyway opening 48. As such, prior art electronic token systems can have substantial RF transmission leakage, which can further lead to problems associated with “sniffing” and cloning.

The concept of “guiding” the energy through a magnetic circuit serves to reduce the propagation in the near-field mode. Magnetic fields flow from the north pole of the magnet, out into space, and back into the south pole of the magnet. The magnetic field occurs in space near the magnet (in this case, the loop antenna) where a change in energy attributable to the magnet can be detected. Multiple loops in the transmitting antenna create a strong near-field magnetic field by combining with the fields from the other loops, thereby concentrating the magnetic field in the center of the coil. When originating from a well-wound antenna, such a field is similar to that of a bar magnet—within the center of the coil it is strong and uniform—in that the field flows from the north pole of the coil into space and returns to the south pole of the coil. When the receiving RFRM's antenna intersects the near-field, its own multiple overlapping loops allows the magnetic field to be “harvested” and turned into electric currents that are carried into and used to power the RFRM.

There are ways to influence this transfer of magnetism. For any given material that the magnetic field propagates through, it will be attenuated by the material. The material's permeability describes the ease with which a magnetic field propagates through the material—a material's permeability property arises from the field strength it takes for the magnetic flux to establish itself within the material. The depth of penetration of a magnetic field through a material is given by 1/√ Frequency*Permeability. Consequently, for a given material, the higher the frequency of the signal, the lower the depth of penetration of magnetic flux through a specific material. Iron is an excellent “conductor” of magnetic energy (versus air) and is traditionally used to “confine” the magnetic fields within transformers.

The various embodiments of the present disclosure provide novel and advantageous features and improvements for electronic data carrier systems and RF electronic token systems and concepts. The novel and advantageous features include, among other things, features relating to, and solving problems for, RF transmission leakage and suppression, “sniffing,” and counterfeiting, each of which can be useful in areas such as data logging, access control, cashless vending, CIKs, etc. The additional features include, but are not limited to, a skeleton key-style token, stepped-down token and receptacle, interference rings, frequency detuning, a keeper and variants thereof for directing, channeling, or shielding magnetic fields, and specific uses of dielectric materials. These features are further described below.

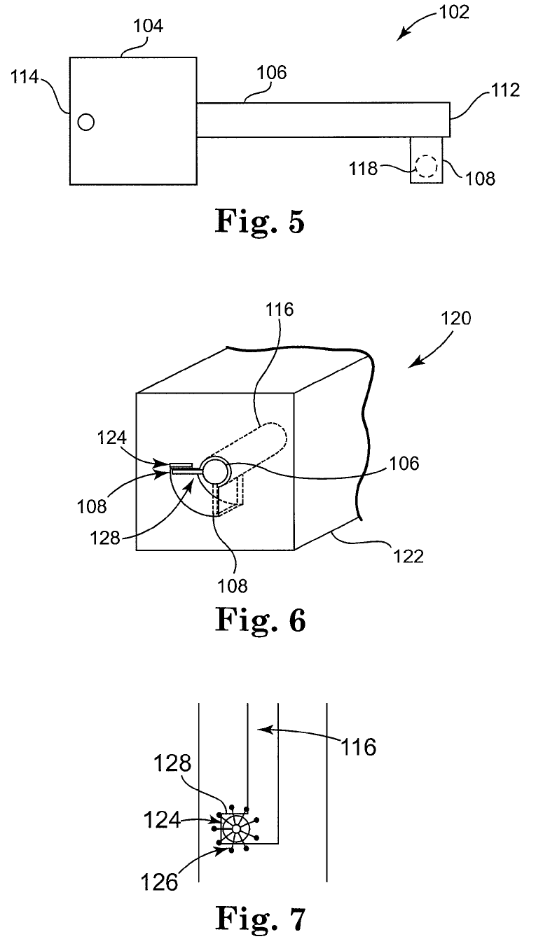

Skeleton Key-Style Token—In one embodiment of the present disclosure, illustrated in FIGS. 5 and 6, an electronic token data carrier system includes a RFRM token device 102 and a corresponding token receptacle 120. The token 102 is configured and arranged for insertion into an opening of a token receptacle 120.

A portable RFRM token device 102 may be configured in a shape similar to a skeleton key, having a head 104, a shank 106, and a receiver tip 108 extending radially, or outward from a rotational axis, of the shank 106. The token 102 may comprise a rugged, non-conductive enclosure having a distal end 112 and a proximal end 114. The token 102 includes an RF data exchange circuit disposed in and supported by the enclosure. The circuit may include a non-volatile, reprogrammable memory, and may be located anywhere within the token 102, such as, but not limited to, within the area of the head 104 or shank 106. The token 102 may include a magnetic coupling member 118 disposed in the enclosure at the distal end 112 within the receiver tip 108.

A token receptacle 120 can include a housing 122 having a slot or keyway 116 configured and arranged to receive the skeleton key-style token 102. The keyway 116 has a distal end and a proximal end. The token receptacle 120 may include a circuit configured and arranged to be mounted in the housing 122. The circuit, as with the prior art embodiments, can include electrical traces or pathways, a processor (e.g., a suitable CPU), and at least one embedded application, addressable I/O lines, and/or communication bus/interface, that are operable with the token device 102. The CPU, addressable I/O lines, and electrical traces or pathways can be any suitable CPU, addressable I/O lines and/or communication bus/interface, and electrical wires known in the electrical and computer art. The at least one embedded application can be any type of user application, such as reader/writer modules, etc., that are known in the electrical and computer art. The token receptacle 120 further includes a transceiver antenna member 124. The transceiver antenna member 124 is disposed in the housing 122 near the distal end of the keyway 116.

In use, the skeleton key-style token 102 is fully inserted into the keyway 116 of the receptacle 120, whereby the distal end 112 of the token 102 is disposed at or adjacent to the distal end of the keyway 116. As shown in FIG. 6 in dashed line, upon insertion of the token 102, the receiver tip 108 and magnetic coupling member 118 are disposed relatively away from the transceiver antenna member 124 of the token receptacle 120. This may be referred to herein as the “insertion” position. The magnetic field of the magnetic coupling member 118 is substantially orthogonal, or otherwise at a non-parallel alignment, to the magnetic field 126 (FIG. 7) of the transceiver antenna member 124. Substantially no energy is coupled between the magnetic fields of the token 102 and receptacle 120.

Once the token 102 is turned a certain amount, such as approximately ninety (90) degrees, to a position predetermined by the token 102 and the keyway 116 of the token receptacle 120 in which it is inserted and turned, the receiver tip 108 and magnetic coupling member 118 are disposed proximate the transceiver antenna member 124, minimizing the air gap between the magnetic coupling member 118 and the transceiver antenna member 124 and substantially aligning the magnetic fields of the magnetic coupling member 118 and the transceiver antenna member 124. This may be referred to herein as the “activation” position. The magnetic coupling member 118 and the transceiver antenna member 124 are well-coupled, and RF signals forming a communication pathway are thus generated in the transceiver antenna member 124 to enable a transaction between the circuit of the token 102 and the circuit of the receptacle 120. In some embodiments, a user will feel a tactile or hear an auditory feedback when the token is turned and the magnetic coupling member 118 and the transceiver antenna member 124 are in the activated position.

Additionally, as illustrated in FIG. 7, when coupled, the magnetic fields of the magnetic coupling member 118 and transceiver antenna member 124 are substantially contained in a side chamber 128 of the receptacle 120. RF transmissions have difficulty making right angle turns. Because the magnetic fields of the magnetic coupling member 118 and transceiver antenna member 124 are substantially contained in a side chamber 128, an increase in the containment of stray RF energy is provided. As can be seen from FIG. 7, the RF field lines are not axially aligned with the keyway 116. Accordingly, a token device external to the panel in which the receptacle 120 is mounted cannot “talk” with the transceiver antenna member 124. Additionally, due to the minimized RF transmission leakage when the magnetic coupling member 118 and transceiver antenna member 124 are coupled, “sniffing” and cloning devices will have increased difficulty in extracting/reading the RF transmission between the magnetic coupling member 118 and transceiver antenna member 124. These advantages prevent “accidental” or “casual” activation by authorized keys, prevent those keys that do not conform with the mechanical alignment of the receptacle, i.e. unauthorized keys, from becoming active or causing false triggering, and prevent problems associated with “sniffing” and cloning.

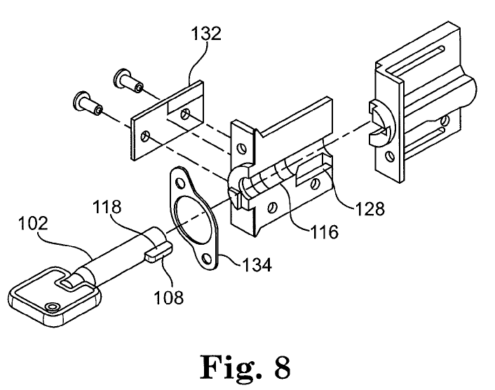

FIG. 8 illustrates an exploded perspective view of one embodiment of a skeleton key-style electronic token data carrier system. As can be seen, the transceiver antenna member 124 and circuit of the receptacle 120 may be positioned on a printed circuit board 132. The printed circuit board 132 may be positioned so that the transceiver antenna member 124 magnetically couples with the magnetic coupling member 118 of the token 102, as described above, upon rotation of the token 102 inserted into the receptacle 120. The electronic token system may further include a RF-shielding, water and dust intrusion gasket 134 for adding further security from RF transmission leakage and water and dust infiltration. Additionally, the enclosure of the token 102 may be molded plastic for increased strength, durability, and ruggedness. The circuit and the magnetic coupling member 118 of the token 102 are housed inside the enclosure and are not exposed to the outside environment. Accordingly, token detection and communication of the various embodiments of the present disclosure are performed without physical contact between electrical components/electronics of the token 102 and electrical components/electronics of the token receptacle 120. This substantially reduces the wear and tear on the token 102 and the receptacle 120. Another advantage is that the contactless system allows the electrical components/electronics to be sealed against corrosion, such as galvanic decay, or other hostile environments, such as salt air/spray or chemicals, etc.

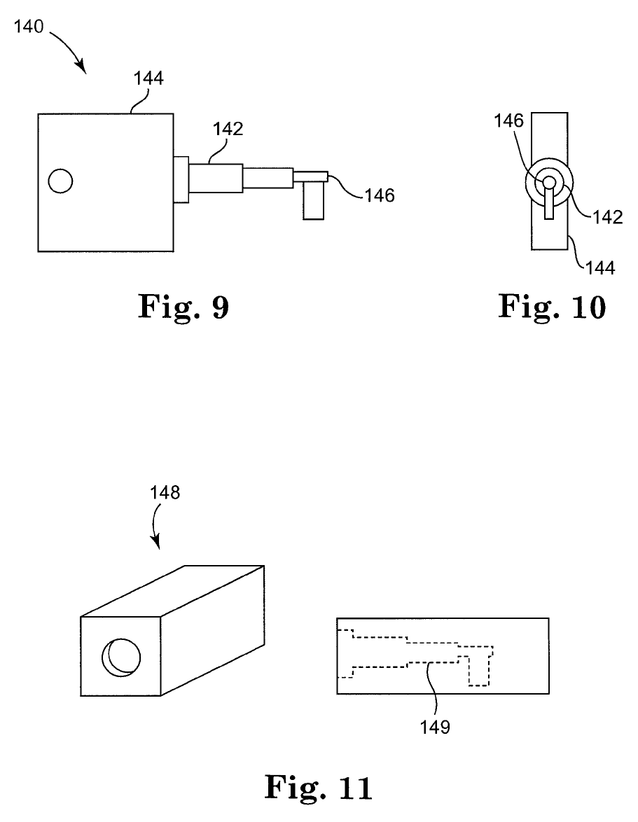

Stepped-Down Token—As stated above, RF transmissions have difficulty making right angle turns. Therefore, another embodiment of an electronic token 140, illustrated in FIGS. 9 and 10, may include a stepped-down shank 142. Although illustrated in combination with the skeleton key-style token described above, a stepped-down shank may be used with any RFRM token device, such as, but not limited to, the token disclosed in U.S. Pat. No. 7,158,008. A stepped-down shank 142 made with suitable RF-reflecting material or coating can generate RF reflection by increasingly “stepping down” the diameter of dimensions of the token shank 142 from the token head 144 toward the token tip 146. Although shown having three (3) steps down, a stepped-down shank 142 may include any suitable number of steps down, including one (1) or more steps down. The radial distance of the step down of each step need not be congruent; any step down along the shank 142 may have a greater or shorter radial distance than another step down along the shank 142. Similarly, the axial distance between steps down need not be equal; the axial distance between two (2) steps down can be greater or shorter than the axial distance between any other two (2) steps down. Furthermore, a shank having a circular cross-section is exemplary, and it is recognized that a shank having a cross-section of any shape, such as squared or rectangular, may also be suitably stepped-down.

FIG. 11 illustrates a suitable token receptacle 148 for receiving a stepped-down token 140. As before, although illustrated in combination with the skeleton key-style token receptacle described above, a stepped-down receptacle may be used with any suitable stepped-down RFRM token device, such as, but not limited to, a stepped-down version of the token device disclosed in U.S. Pat. No. 7,158,008. As can be seen, the interior keyway 149 of the token receptacle 148 is correspondingly “stepped-down.” Because RF transmissions have difficulty making right angle turns, any portions of the RF field that are aligned with the keyway 149 can increasingly be cut down by the stepped-down walls of the stepped-down token 140, thereby increasing the containment of stray RF energy.

Interference Rings—In another embodiment of the present disclosure, destructive interference patterns may be used to decrease RF transmission leakage. This may be accomplished by creating RF reflections that are out of phase, such as but not limited to 45 degrees out of phase, 90 degrees out of phase, 180 degrees out of phase, etc., with the RF transmissions leaking from the distal end of the token receptacle to the proximal end of the token receptacle and out the receptacle opening, thereby at least partially canceling the leaked RF field with reflected waves.

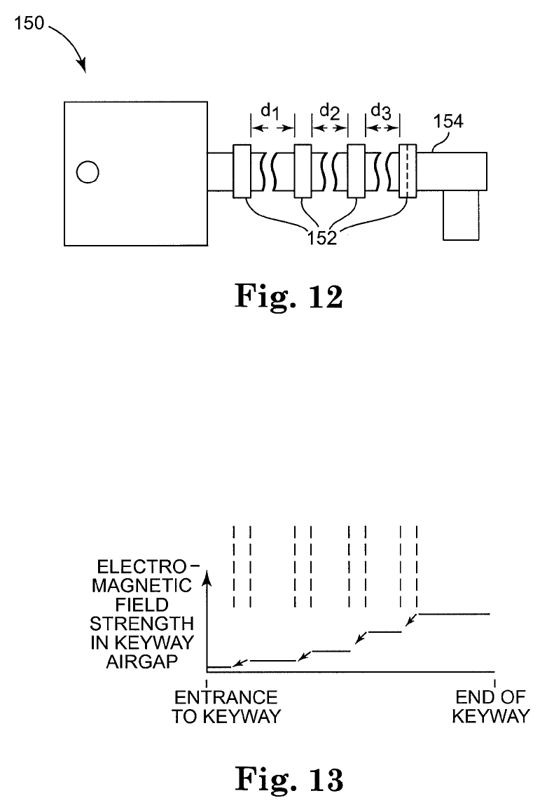

In one embodiment of an electronic token device 150, illustrated in FIG. 12, such destructive interference patterns may arise from reflections caused by including interference “rings” 152 that are spaced at substantially even fractional wavelength increments along the token shank 154. In some embodiments, the fractional wavelength increments may be one-half (½) the wavelength of the RF transmission, one-third (⅓) the wavelength of the RF transmission, one-fourth (¼) the wavelength of the RF transmission, or any other suitable fraction of the wavelength of the RF transmission. In other embodiments, as shown in FIG. 12, the interference rings 152 need not be evenly spaced. The distance between any two (2) interference rings 152 along the token shank 154 may be any fraction of the wavelength of the RF transmission and can be the same or different from the distance between any other two (2) interference rings 152 along the token shank 154. Similarly, the width of each interference ring 152 can be the same or different from the width of any other interference ring 152 along the token shank 154. Although shown having four (4) interference rings 152, a token shank 154 may include any suitable number of interference rings 152, including one (1) or more interference rings 152. The material or surface layer of the interference rings 152 may be selected for reflective properties at the frequencies involved in RF transmissions. As stated above, although illustrated in combination with the skeleton key-style token receptacle described above, interference rings may be used with any suitable RFRM token device, such as, but not limited to, a the token device disclosed in U.S. Pat. No. 7,158,008.

In a particular embodiment, the distance between the interference rings 152 may be determined as submultiples of the RF carrier wavelength using the equation dₙ=λ/x, wherein d is the axial distance between two interference rings 152, n is an integer representing the position of the space between the two interference rings 152, wherein the integer increases as the spaces between the interference rings 152 move toward the distal end of the token shank 154, λ is the wavelength of the RF transmission emanating from the transceiver antenna, and x is an integer.

FIG. 13 is a graph that conceptually illustrates the destructive interference caused by the interference rings 152 along the token shank 154 of the token 150 illustrated in FIG. 12. As is shown, the RF energy available to radiate through the keyway and out the opening of a token receptacle can be substantially reduced.

Frequency Detuning—In further embodiments, a method of detuning, or “pulling,” the RFRM token device from a default operating frequency to, upon insertion in the token receptacle, the center frequency that the transceiver antenna member of the token receptacle is operating at. In some systems, such as systems using UHF for example, bringing a coil antenna near metal will inhibit the flow of the magnetic field around the coil. This will result in a loss of efficiency of the coil antenna and usually a significant retuning of its center frequency. Typically, design engineers are aware of this and will make appropriate design choices so that the affects of nearby metal are eliminated or mitigated. However, if intentionally introduced into an electronic token data carrier system, this property can be used to enhance the security.

In one embodiment, the magnetic coupling member of the RFRM token device may be configured to operate at a default operating frequency, such as, for exemplary purposes only, 135 kHz. The magnetic coupling member may operate at any suitable default operating frequency. The magnetic coupling member will generally operate at the default operating frequency when the token device is external to the token receptacle having the metal element. The token receptacle may be provided with a metal element. The metal element can be positioned at any suitable position within, on, or proximate to the token receptacle, and the position of the metal element can be selected based on the amount of specified detuning desired. The metal element may comprise any suitable metal, such as steel or ferrite, and may also be selected based on the amount of specified detuning desired. The transceiver antenna member of the token receptacle having the metal element will generally operate at a center frequency different from the default operating frequency of the token device, such as, for exemplary purposes only, 125 kHz.

Upon insertion of the token device into the token receptacle, the magnetic coupling member of the RFRM token device can be configured to be “pulled,” by the metal element, from the default operating frequency to the center frequency of the RF transceiver antenna member, thereby strengthening the magnetic coupling of the magnetic coupling member and transceiver antenna member. One effect of such configuration is that any other industry-standard RFRM with a typical antenna that made its way in, or proximate, the keyway would be pulled off-frequency and would not couple power efficiently enough to power-up and communicate with the transceiver antenna member. Additionally, “pulling” the frequency of the RFRM token device to a different frequency upon insertion into the token receptacle makes it more difficult for someone to “sniff” the communications between the token device and token receptacle. For example, if a token were stolen, or otherwise made available to an undesirable party, that party may attempt to clone the token. However, the cloned token would be made under the false assumption that the token would remain operating at, for example, 135 kHz while received in the token receptacle. Similarly, if an undesirable party “sniffed” the RF transmissions from the token receptacle while a token was in communication with the token receptacle, the sniffer would receive transmissions in, for example, 125 kHz. If the sniffer then designed a counterfeit token operating at 125 kHz, the token would be pulled out of the operating frequency of the token receptacle once inserted into the token receptacle, thereby avoiding communication between the transceiver antenna member of the receptacle and magnetic coupling member of the token.

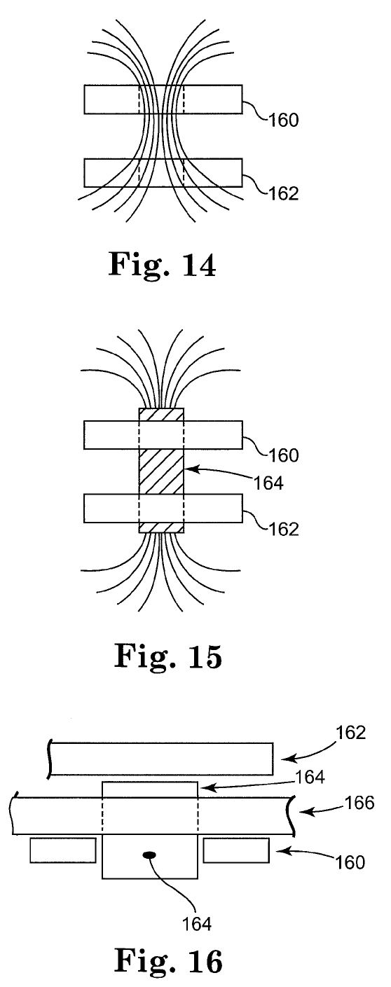

Keeper—FIG. 14 conceptually illustrates the magnetic field lines between a transceiver antenna member 160 of a token receptacle and a magnetic coupling member 162 of a electronic token device. As can be seen, because there is air, or another low permeability material, in the space between the transceiver antenna member 160 and the magnetic coupling member 162, portions of the magnetic field are not being captured by the magnetic coupling member 162 (i.e., receiving coil). Therefore, higher transmit power is used to address the inefficiency, leading to higher probability of detectable RF emissions. A skeleton key-style token, as described above, can help reduce the leakage of detectable RF emissions by bringing the magnetic coupling member 162 in very close proximity to the transceiver antenna member 160.

In some embodiments, illustrated in FIGS. 15 and 16, however, a highly permeable material, such as, but not limited to, ferrite, can be used to direct or channel substantially more of the magnetism, or magnetic field, from the transceiver antenna member 160 to the magnetic coupling member 162. By coming into substantially direct contact or effectively zero air gap, the vast majority of the magnetic field will be channeled through the permeable “bridge” between the RFRM token device and the token receptacle's transceiver antenna, effectively minimizing the amount of transmit power needed and effectively minimizing external emanations of the magnetic field. The physical device that accomplishes this channeling effect is sometimes referred to as a “keeper.”

In one embodiment, illustrated in FIG. 15, a keeper 164 may be positioned within a token receptacle, such that the keeper 164 extends between the transceiver antenna member 160 and the magnetic coupling member 162 and extends through the center of the coils of the transceiver antenna member 160 and the magnetic coupling member 162. As is illustrated conceptually in FIG. 15, the magnetic field lines are directed by the keeper 164 between the transceiver antenna member 160 and the magnetic coupling member 162, such that detectable RF emissions can be substantially controlled. In some embodiments, the keeper 164 may be positioned within or integral with the token receptacle. The token device can be configured such that the keeper 164 of the token receptacle can be received by the token device within the magnetic coupling member 162. However, it is also recognized that the token device may include the keeper 164, and the token receptacle can be configured to receive the keeper 164 within the transceiver antenna member 160.

In an alternative embodiment, illustrated in FIG. 16, a keeper 164 may be positioned within a token receptacle, such that the keeper 164 extends between the transceiver antenna member 160 and the magnetic coupling member 162 and extends through the center of the coils of the transceiver antenna member 160. However, the keeper 164 may not extend through the coils of the magnetic coupling member 162 of the token device. FIG. 16 also illustrates the housing of the token receptacle 166, for illustrative purposes only. While such an embodiment may not be as effective as the embodiment of FIG. 15 at directing the magnetic field lines between the transceiver antenna member 160 and the magnetic coupling member 162, substantial channeling of the magnetic field lines will still be accomplished. Thus, detectable RF emissions can again be substantially controlled. As above, in some embodiments, the keeper 164 may be positioned within or integral with the token receptacle. However, it is also recognized that the token device may include the keeper 164. Furthermore, other suitable configurations of an electronic token data carrier system having a keeper are recognized and may be used. For example, the keeper 164 may extend from the transceiver antenna member 160 to any distance up to and/or through magnetic coupling member 162, such as halfway through the coils of the magnetic coupling member 162.

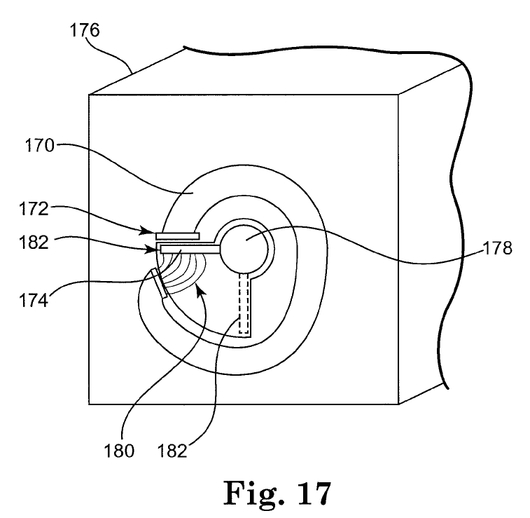

FIG. 17 illustrates a variant of a keeper 170 used to channel the magnetic field between the transceiver antenna member 172 and the magnetic coupling member 174. As illustrated in FIG. 17, the highly permeable keeper, such as, but not limited to, a keeper comprised of ferrite, can extend from the transceiver antenna member 172 of the token receptacle 176 through the token receptacle 176 and away from the magnetic coupling member 174 of a skeleton key-style token device 178. The keeper 170 may extend substantially concentrically through the token receptacle 176 around the token shank. As can be seen conceptually in FIG. 17, the magnetic field lines 180 between the transceiver antenna member 172 and the magnetic coupling member 174 may be channeled through the keeper 170 around the token shank 180 and to the bottom side of the token receiving tip 182 and back to the transceiver antenna member 172. The keeper 170 may be substantially located at the distal end of the token receptacle 176. As further illustrated in FIG. 17, upon insertion of the skeleton key-style token 178, the receiving tip 182 (shown in dashed line) having the magnetic coupling member 174 will be away from the transceiver antenna member 172. However, upon turning the token 178 to an activation position, the receiving tip 182 (shown in solid line) and magnetic coupling member 174 of the token device 178 will be proximate the transceiver antenna member 172 of the token receptacle 176. As such, during communication between the transceiver antenna member 172 and the magnetic coupling member 174, detectable RF emissions are again substantially minimized.

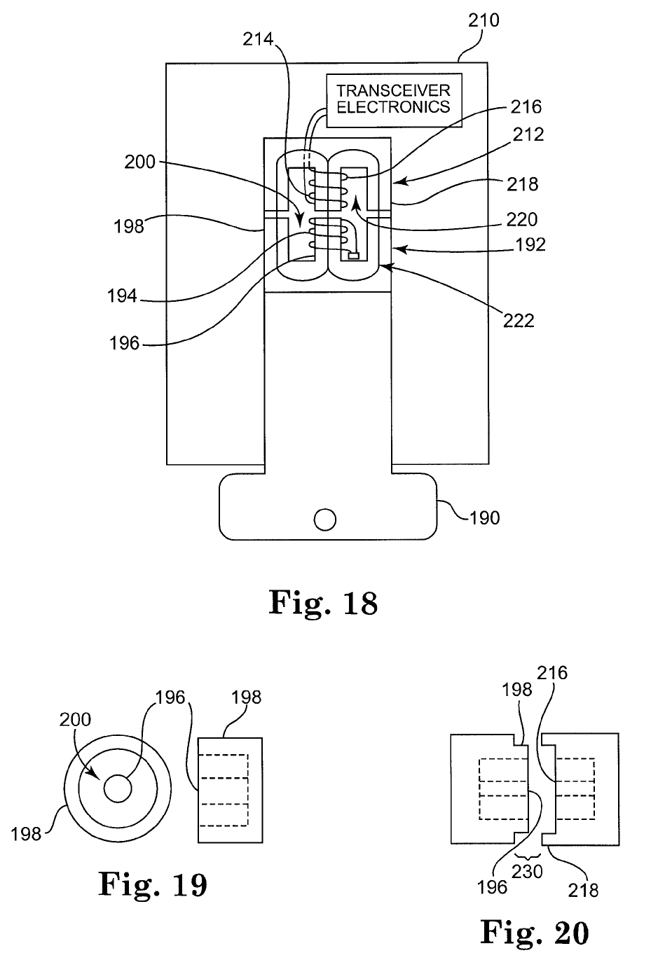

Shielded RFRM—FIGS. 18-20 illustrate further embodiments of directing the magnetic field between the transceiver antenna member and magnetic coupling member. As shown in FIGS. 18 and 19, an electronic token device 190 may include a magnetic coupling member 192. The magnetic coupling member 192 may include coils 194 around a central extension member 196. The magnetic coupling member 192 may further include a circumferential extension member 198, with an air gap 200, or other low permeability material, positioned between the central extension member 196 and circumferential extension member 198. The token receptacle 210 may include a transceiver antenna member 212 having substantially the same configuration as the magnetic coupling member 192 of the token 190. That is, the transceiver antenna member 212 may include coils 214 around a central extension member 216. The transceiver antenna member 212 may further include a circumferential extension member 218, with an air gap 220, or other low permeability material, positioned between the central extension member 216 and circumferential extension member 218.

Upon insertion of the token 190 into the token receptacle 210, the central extension member 196 of the token 190 will become proximate the central extension member 196 of the transceiver antenna member 212 of the token receptacle 210 and the circumferential extension member 198 of the token 190 will become proximate the circumferential extension member 218 of the token receptacle 210, thereby directing the magnetic field lines 222 between the transceiver antenna member 212 and magnetic coupling member 192 through the central extension members 196 and 216 and the circumferential extension members 198 and 218, as conceptually illustrated in FIG. 18, thereby substantially minimizing detectable RF emissions.

In some embodiments, an air gap, or other low permeability material, may be present between the transceiver antenna member 212 and magnetic coupling member 192. However, in other embodiments, the magnetic coupling member 192 may become substantially proximate the transceiver antenna member 212 upon insertion of the token 190 into the token receptacle 210 such that the gap between the transceiver antenna member 212 and magnetic coupling member 192 is eliminated or substantially reduced.

While illustrated as an electronic token data carrier system having a token with a shank having a circular cross-section, it is recognized that the token may have any other suitably shaped cross-section, such as but not limited to, squared or rectangular. FIG. 20 illustrates a further embodiment, wherein the token and token receptacle include a mating element or inter-locking element 230 for increased alignment and/or retention of the token 190 within the token receptacle 210. It is also recognized that other configurations for a magnetic coupling member and transceiver antenna member will achieve the same result and are within the spirit and scope of the present disclosure.

Further embodiments may also include a micro-switch, Hall effect switch, contacts on the token, or other detection system and methods for detecting when a token 190 has been inserted into token receptacle 210. The transceiver antenna member 212 can then be configured to energize only upon insertion and detection of a token 190.

Dielectric Material Selection and Arrangement—The token and receptacle material can be selected for increased RF absorption, dielectric properties, water tightness, strength and ruggedness, and/or its ability to accept conductive coatings. The material used may be based upon the embodiment of token and receptacle desired and the specifications of the user.

A dielectric is a material that is resistant to passing an electric current. Passive RFRMs gather electricity from the transceiver's magnetic field, so the material they are affixed to can dramatically affect their performance. Plastics have varying dielectric properties and can be controlled using additives, such as carbon. Even dielectrics that have the property of being transparent to incident RF can degrade the RFRM's performance (to various degrees) if the transceiver antenna is placed in direct contact with it. This is because electric charge decreases as it passes through a dielectric material and the velocity of the wave changes. This is similar to the effect of light “bending” when it hits water. This refractive/absorptive feature can be used to scatter and reduce the intensity of any far-field effects of the RF transmissions. Therefore, selection and arrangement of material for the token and token receptacle can be used to reduce leakage of RF transmissions. In some embodiments, a token or token receptacle may comprise of more than one material or dielectric in a predetermined arrangement. Each time RF emissions pass from one material to the next the RF emissions may be refracted or absorbed further, increasingly reducing detectable RF emissions. For example, an interference ring on the shank of a token, such as those shown in FIG. 12, can comprise of two dielectrics with different permeability properties. That is, an interference ring may be divided equally or unequally into two separate dielectrics coupled together to form a single interference ring, as shown by the dashed line in FIG. 12.

A token and receptacle system according to the above principles may incorporate a combination of the above features. For example, the token may include a stepped-down shank and a keeper or interference rings and one or more of the shielding arrangements discussed. The various combinations selected will depend on the degree of security required and the RF frequencies used.

Although the present invention has been described with reference to preferred embodiments, persons skilled in the art will recognize that changes may be made in form and detail without departing from the spirit and scope of the invention. For example, each of the various embodiments of the present disclosure described above may be used alone or in combination with one or more of the other embodiments to further reduce RF transmission leakage and curb “sniffing” and cloning.

We claim:

1. An electronic token system for data exchange with a device comprising:
a token receptacle operably connected to the device, said receptacle having an insertion opening and an RF transceiver antenna;
a portable token for mating with the receptacle comprising:
a RF data exchange circuit;
an enclosure with a proximate end and a distal end for enclosing the RF data exchange circuit;
a magnetic coupling member having a generally planar antenna placed adjacent the distal end of the token and in communication with the RF data exchange circuit, said planar antenna being mounted in a planar projection extending outward from a rotational axis of the enclosure; and
a keyway in the token receptacle for receiving and guiding insertion of the portable token, said keyway configured to receive the token in an insertion position in which the magnetic coupling member is not operably coupled to the token receptacle's RF transceiver antenna and, upon token rotation, to guide the token to an activation position in which the magnetic coupling member is operably coupled to the RF transceiver antenna.

2. The electronic token system of claim 1, wherein the planar projection provides token retention in the token receptacle when the portable token is in the activation position.

3. The electronic token system of claim 1, wherein the system has RF suppression features selected from the group comprising:
at least one step down surface on a shank of the portable token;
at least one interference ring on a shank of the portable token;
at least one frequency detuning element operably connected to the magnetic coupling member in its activation position for detuning an operating frequency of the magnetic coupling member;
at least one keeper element operably connected to the RF transceiver antenna or the magnetic coupling member providing a preferred high-permeability path for channeling the magnetic flux extending between the RF transceiver antenna and the receiving antenna when the token is in the activation position;
shielding substantially enclosing the magnetic coupling member and transceiver antenna and guiding the magnetic field surrounding the RF transceiver antenna and the receiving antenna; and
at least one interface formed by a first and a second layer of dielectric material having substantially different dielectric qualities, said interface being oriented to deflect RF transmissions traveling generally axially within the keyway from their generally axial path.

4. The electronic token system of claim 3, wherein the step down surface on the shank of the portable token comprises a surface extending radially from the shank.

5. The electronic token system of claim 3, wherein the at least one interference ring on a shank of the portable token comprises a plurality of generally evenly spaced interference rings.

6. The electronic token system of claim 3, wherein the at least one interference ring on a shank of the portable token comprises a plurality of unevenly spaced interference rings.

7. The electronic token system of claim 6, wherein the spacing between the interference rings is determined using the equation:
dₙ=λ/x;
wherein d is the axial distance along the token shank between two interference rings, n is an integer representing the location of the space between the two interference rings, wherein the integer increases as the spaces between the interference rings move toward the distal end of the token shank, λ is the wavelength of the RF transmission emanating from the transceiver antenna, and x is an integer.

8. The electronic token system of claim 3, wherein the at least one frequency detuning element comprises one or more metals or dielectrics.

9. The electronic token system of claim 8, wherein the token has a first operating frequency that, upon insertion into the token receptacle, is detuned by the at least one frequency detuning element to a second operating frequency substantially matching the operating frequency of the token receptacle.

10. The electronic token system of claim 3, wherein the keeper element comprises ferrite or iron.

11. The electronic token system of claim 10, wherein the keeper element extends through the RF transceiver antenna;

12. The electronic token system of claim 11, wherein the keeper element further extends through the receiver antenna.

13. The electronic token system of claim 3, wherein keeper extends substantially concentrically around the keyway.

14. An electronic token system for data exchange with a device comprising:
a token receptacle operably connected to the device, said receptacle having an insertion opening and an RF transceiver antenna;
a portable token for mating with the receptacle comprising:
a RF data exchange circuit;
an enclosure with a proximate end and a distal end for enclosing the RF data exchange circuit;
a magnetic coupling member having a generally planar antenna placed adjacent the distal end of the token and in communication with the RF data exchange circuit; and
at least one step down surface extending radially from a shank of the token.

15. An electronic token system for data exchange with a device comprising:
a token receptacle operably connected to the device, said receptacle having an insertion opening and an RF transceiver antenna;
a portable token for mating with the receptacle comprising:
a RF data exchange circuit;
an enclosure with a proximate end and a distal end for enclosing the RF data exchange circuit;
a magnetic coupling member having a generally planar antenna placed adjacent the distal end of the token and in communication with the RF data exchange circuit; and
shielding substantially enclosing the magnetic coupling member and transceiver antenna and guiding the magnetic field surrounding the RF transceiver antenna and the receiving antenna when the token is inserted into the token receptacle.
